(19) United States
(12) Patent Application Publication
(10) Pub. No.: US 2015/0318118 A1
(43) Pub. Date: Nov. 5, 2015

(54) TANTALUM CAPACITOR AND METHOD OF MANUFACTURING THE SAME

(71) Applicant: SAMSUNG ELECTRO-MECHANICS CO., LTD., Suwon-si (KR)

(72) Inventors: Hyoung Sun HAM, Suwon-Si (KR); Jun Suk JUNG, Suwon-Si (KR); Jae Hyuk CHOI, Suwon-Si (KR); Jae Yik HOWANG, Suwon-Si (KR)

(21) Appl. No.: 14/339,026

(22) Filed: Jul. 23, 2014

(30) Foreign Application Priority Data
Apr. 30, 2014 (KR) 10-2014-0052759

(51) Int. Cl. H01G 9/10; H01G 13/00; H01G 9/012

(52) U.S. Cl. CPC H01G 9/10; H01G 9/012; H01G 13/003; H01G 13/006

(57) ABSTRACT

In a tantalum capacitor, a bending angle between a positive electrode terminal part of a positive electrode lead frame and a wire connection part connected to a tantalum wire may be set to 87 to 93° to maintain constant a contact area between a non-insertion region of the tantalum wire and an end portion of the wire connection part at the time of welding and adhering the non-insertion region and the end portion to each other.

### CROSS-REFERENCE TO RELATED APPLICATION

This application claims the benefit of Korean Patent Application No. 10-2014-0052759 filed on Apr. 30, 2014, with the Korean Intellectual Property Office, the disclosure of which is incorporated herein by reference.

### BACKGROUND

The present disclosure relates to a tantalum capacitor and a method of manufacturing the same.

Tantalum (Ta), a metal, is widely used in various industries such as the aerospace industry, the defense industry, and the like, as well as in the electrical products industry, the electronics industry, the mechanical engineering industry, and the chemical industry due to having excellent mechanical or physical properties such as a high melting point, excellent flexibility and corrosion-resistance, and the like.

Such tantalum has a property capable of forming a stable cathode oxide film, and thus, has been widely used as an anode material for a small-sized capacitor. Moreover, recently, the worldwide use of tantalum has sharply increased every year, due to the rapid development of information technology (IT) industries such as the electronics industry and the information communications industry.

Tantalum capacitors use such tantalum.

Among these tantalum capacitors, there is a tantalum capacitor having a structure called a long-bottom structure in which one end portion of the positive electrode lead frame is bent upwardly to be connected to a tantalum wire, thereby improving volume efficiency of a capacitor body.

Among such tantalum capacitors, a tantalum capacitor having a structure known as a long-bottom structure in which one end portion of the positive electrode lead frame is bent upwardly to be connected to a tantalum wire, thereby improving volume efficiency of a capacitor body, may be provided.

However, such a tantalum capacitor having a long-bottom structure according to the related art may be problematic in terms of a high welding defect rate in the case of tantalum wire and a positive electrode lead frame bonded to each other by welding.

### SUMMARY

Some embodiments of the present disclosure may provide a tantalum capacitor capable of decreasing a welding defect rate between a tantalum wire and a positive electrode lead frame.

According to some embodiments of the present disclosure, a tantalum capacitor in which a bending angle between a positive electrode terminal part of a positive electrode lead frame and a wire connection part connected to a tantalum wire is within a range of 87 to 93° may be provided.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a transparent perspective view illustrating a schematic structure of a tantalum capacitor according to an exemplary embodiment of the present disclosure;

FIG. 2 is a cross-sectional view of line A-A′ of FIG. 1;

FIG. 3 is an enlarged cross-sectional view of part D of FIG. 2; and

FIG. 4 is an enlarged cross-sectional view of part C of FIG. 2.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

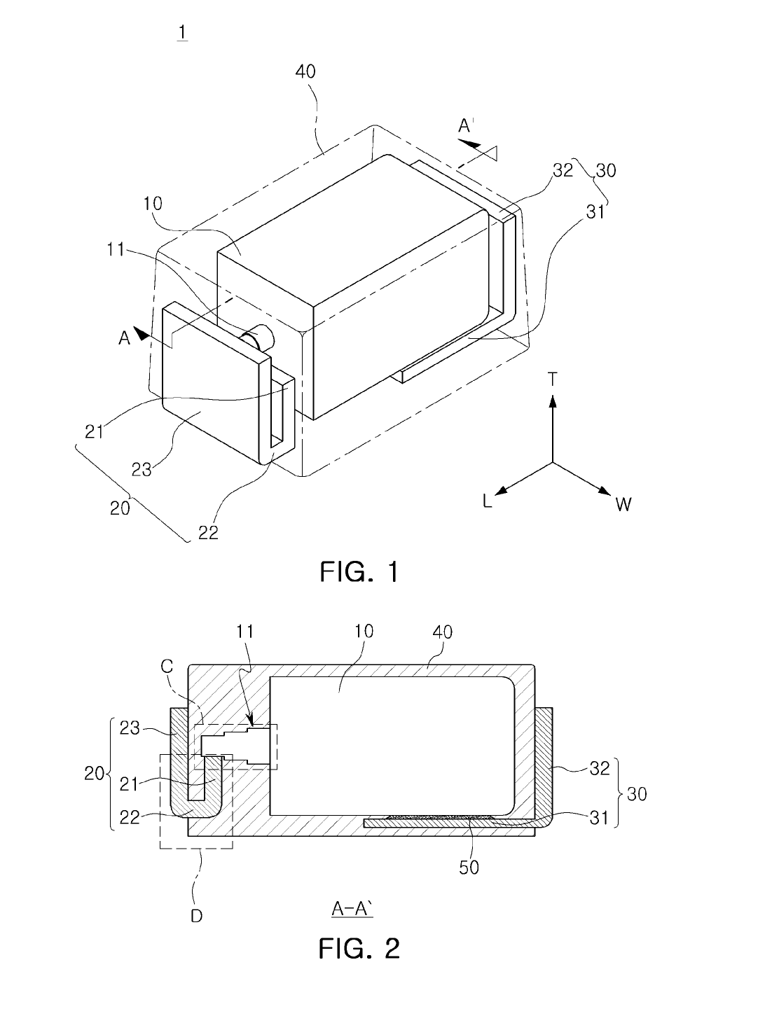

A direction of a hexahedron will be defined in order to clearly describe an exemplary embodiment of the present disclosure. In FIG. 1, L, W and T refer to a length direction, a width direction, and a thickness direction, respectively.

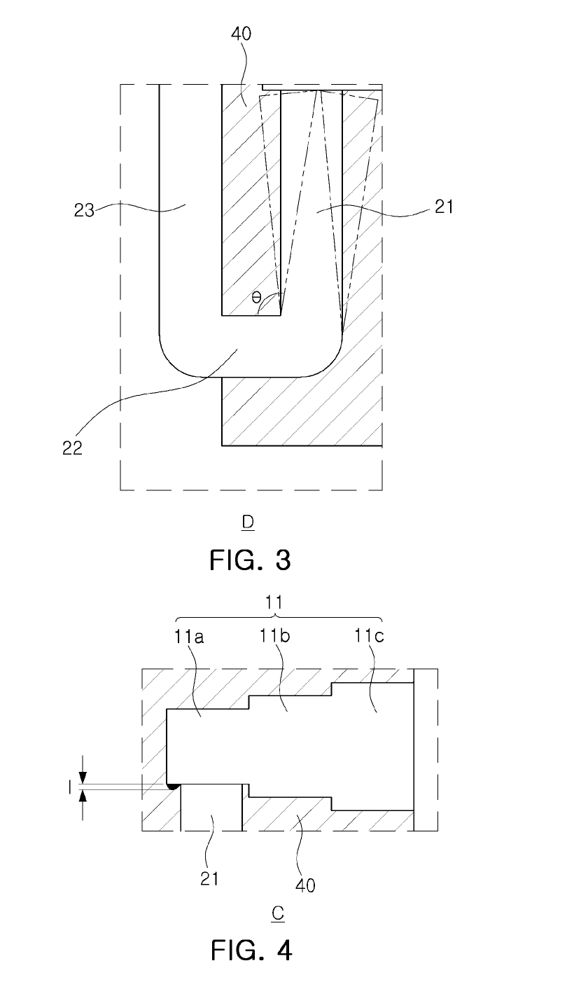

FIG. 1 is a transparent perspective view illustrating a schematic structure of a tantalum capacitor according to an exemplary embodiment of the present disclosure; FIG. 2 is a cross-sectional view of line A-A′ of FIG. 1; and FIG. 3 is an enlarged cross-sectional view of part D of FIG. 2.

Referring to FIGS. 1 and 2, a tantalum capacitor 1 according to an exemplary embodiment of the present disclosure may include a capacitor body 10; a tantalum wire 11; a molding part 40; a positive electrode lead frame 20; and a negative electrode lead frame 30.

The capacitor body 10 may be formed using tantalum and may serve as a negative electrode.

The capacitor body 10 may be configured of a porous valve-acting metal body and may be manufactured by sequentially forming a dielectric layer, a solid electrical layer, and a negative electrode layer on a surface of the porous valve-acting metal body.

As an example, the capacitor body 10 may be manufactured by mixing and stirring tantalum powder particles and a binder at a predetermined ratio, compressing the mixed powder particles to form a rectangular parallelepiped, and then sintering the formed rectangular parallelepiped at a high temperature under high vacuum.

In more detail, the tantalum capacitor may have a structure using a gap formed at the time of sintering and hardening tantalum powder particles, and the capacitor body 10 may be provided by forming tantalum oxide (Ta₂O₅) on a tantalum surface using an anodic oxidation method, forming a manganese dioxide (MnO₂) layer or a conductive polymer layer, which is an electrolyte, on this tantalum oxide used as a dielectric, and forming a carbon layer and a metal layer on the manganese dioxide layer and the conducive polymer layer.

In this case, carbon and silver (Ag) may be applied to a surface of the capacitor body 10, as necessary.

The carbon may be to decrease contact resistance of the surface of the capacitor body 10, and the silver (Ag) may be to improve electric connectivity with the negative electrode frame 30.

Hereinafter, in the exemplary embodiment of the present disclosure, for convenience of explanation, a front surface refers to a surface in a direction in which the tantalum wire 11 is led from the molding part 40, both side surfaces refer to surfaces in a width direction intersecting with the front surface, and upper and lower surfaces refer to surfaces in a thickness direction of the capacitor body.

The tantalum wire 11 may serve to a positive electrode.

The tantalum wire 11 may include an insertion region positioned in the capacitor body 10 and a non-insertion region 11a exposed through one end surface of the capacitor body 10 in a length direction.

In addition, the tantalum wire 11 may be inserted into a mixture of the tantalum powder particles and the binder to be mounted therein before compressing the mixed powder particles of the tantalum powder particles and the binder.

For example, the capacitor body 10 may be manufactured by inserting the tantalum wire 11 into the tantalum powder particles mixed with the binder to then be mounted therein so as to form a tantalum element having a necessary size and then sintering the tantalum element at a temperature of about 1,000 to 2,000° C. under high vacuum atmosphere (10⁻⁵ torr or less) for about 30 minutes.

The molding part 40 may be formed by transfer-molding a resin such as epoxy molding compound (EMC), or the like, so as to enclose the capacitor body 10 and the tantalum wire 11.

Here, the molding part 40 may be formed so that the positive electrode lead frame 20 and the negative electrode lead frame 30 are partially exposed through both end surfaces thereof in the length direction.

The molding part 40 may not only serve to protect the tantalum wire 11 and the capacitor body 10 from the outside, but also serve to insulate the capacitor body 10 and the positive electrode lead frame 20 from each other.

The positive electrode lead frame 20 may include a positive electrode terminal part partially exposed through one end surface of the molding part 40 in the length direction thereof and a wire connection part 21 connected to the non-insertion region of the tantalum wire 11.

Here, the positive electrode terminal part may include a first portion 22 positioned in the molding part 40 and having the wire connection part 21 formed at one end portion thereof extended to be bent upwardly, and a second portion 23 exposed through one end surface of the molding part 40 in the length direction, formed at the other end portion of the first portion 22, and bent to be closely adhered to one end surface of the molding part 40 in the length direction.

The wire connection part 21 may be attached to the tantalum wire 11 by, for example, a resistance welding method of performing welding by heating a base material to be bonded, using resistance heat generated by electric conduction through a contact part of the base material and applying pressure to the base material, or the like. For example, the wire connection part 21 may be attached to the tantalum wire 11 by a spot welding method as the resistance welding method. However, the present disclosure is not limited thereto.

Here, since the wire connection part 21 contacts only a lower portion of the tantalum wire 11, a required welding distance may be decreased as compared to a structure according to the related art in which the wire connection part 21 is extended from and contacts one end surface of the molding part 40 in the length direction.

In addition, since the second portion 23 of the positive electrode terminal part is formed on one end surface of the molding part 40 in the length direction, volume efficiency of the capacitor body 10 may be improved as compared to a capacitor having a structure according to the related art in which lead terminals are present in upper and lower portions of a product.

Generally, a tantalum capacitor may easily promote welding stability by adjusting current and welding pressure between the tantalum wire and the positive electrode leadframe. However, such a tantalum capacitor has a problem in which volume efficiency of the capacitor body with respect to an entire volume of a product may be relatively low.

A tantalum capacitor having a long-bottom structure may prevent deterioration of volume efficiency.

However, in the case of the tantalum capacitor having the long-bottom structure, since a thickness of the positive electrode lead frame is provided as a welding area, an area of a welding surface and a welding defect rate may be determined depending on adjustment of bending angles of the wire connection part 21 and a positive electrode terminal part of the positive electrode lead frame 20.

In the exemplary embodiment of the present disclosure, as shown in FIG. 3, the wire connection part 21 may have a bending angle (θ) of 87 to 93° with respect to the first portion 22 of the positive electrode terminal part. Within this range of the banding angle, a contact area between the non-insertion region of the tantalum wire 11 and an end portion of the wire connection part 21 may be constantly maintained, such that a welding defect rate between the tantalum wire 11 and the wire connection part 21 may be significantly decreased to about 3%.

Here, in the case in which the bending angle (θ) of the wire connection part 21 with respect to the positive electrode terminal part is less than 87° or exceeds 93°, when the non-insertion region of the tantalum wire 11 and the wire connection part 21 are welded to each other, the non-insertion region of the tantalum wire 11 may be bent to an internal angle or an external angle due to welding pressure, such that the contact area between the non-insertion region of the tantalum wire 11 and the end portion of the wire connection part 21 may not be constantly maintained. As a result, a large amount of leakage current (LC) jumps and welding defects may occur. In this case, it may be confirmed that a defective rate is about 28%.

Here, LC jumping indicates a phenomenon in which an LC level jumps before and after welding. Generally, when stable welding is performed, LC level values before and after welding may be similar to each other in terms of level.

The negative electrode lead frame 30 may serve as a ground terminal.

In addition, the negative electrode lead frame 30 may include a mounting part 31 on which the capacitor body 10 is mounted and a negative electrode terminal part 32 exposed through the other end surface of the molding part 40 in the length direction thereof at an end portion of the mounting part 31.

Here, the negative electrode terminal part 32 may be bent upwardly so as to be closely adhered to the other end surface of the molding part 40 in the length direction thereof.

Meanwhile, although the case in which the mounting part 31 and the negative electrode terminal part 32 of the negative electrode lead frame 30 are formed integrally with each other is illustrated and described in the exemplary embodiment of the present disclosure, the present disclosure is not limited thereto. For example, the mounting part and the negative electrode terminal part of the negative electrode lead frame may be separately configured through connection therebetween, as necessary.

In addition, the mounting part 31 of the negative electrode lead frame 30 and a mounting surface of the capacitor body 10 may have a conductive adhesive layer 50 disposed therebetween.

The conductive adhesive layer 50 may be formed, for example, by dispensing or dotting a predetermined amount of conductive adhesive containing an epoxy-based thermosetting resin and metal powder particles. However, the present disclosure is not limited thereto.

In addition, the metal powder may contain one or more of sliver (Ag), gold (Au), palladium (Pd), nickel (Ni), or copper (Cu). However, the present disclosure is not limited thereto.

In the exemplary embodiment of the present disclosure, the positive electrode terminal part 23 of the positive electrode lead frame 20 and the negative electrode terminal part 32 of the negative electrode lead frame 30 are formed on both end surfaces of the molding part 40 in the length direction, respectively, to increase an internal volume rate as compared to a tantalum capacitor according to the related art in which the positive electrode lead frame and the negative electrode lead frame are positioned on upper and lower portions thereof, respectively, such that a size of the capacitor body may be significantly increased, thereby improving capacitance while maintaining a size of a product as it is.

Hereinafter, a structure of the non-insertion region of the tantalum wire will be described with reference to FIG. 4.

In the tantalum wire 11 according to the exemplary embodiment of the present disclosure, the non-insertion region of the tantalum wire may include a plurality of regions having different thicknesses and widths.

Although the case in which the non-insertion region includes three regions, for example, first to third regions 11a, 11b, and 11c, having different thicknesses and widths and has a step shape in which a thickness thereof is gradually decreased and a width thereof is gradually increased in a direction in which the tantalum wire 11 is exposed has been shown and described in the exemplary embodiment of the present disclosure, the present disclosure is not limited thereto. For example, the non-insertion region of the tantalum wire may include, for example, two regions or four or more different regions.

Since the thickness of the non-insertion region of the tantalum wire 11 is gradually reduced in the direction in which the tantalum wire 11 is exposed, in the case in which a step portion between upper and lower portions of the non-insertion region is excessively large, the non-insertion region of the tantalum wire 11 is not supported at the time of welding the tantalum wire 11 to the positive electrode lead frame 20, and bending thereof may thus occur.

When the non-insertion region of the tantalum wire 11 is configured to have a multi-step shape in which it includes three or more regions as in the exemplary embodiment of the present disclosure, force supporting the non-insertion region of the tantalum wire 11 at the time of welding the tantalum wire 11 to the positive electrode lead frame 20 is increased to significantly decrease the occurrence of a defect in which the non-insertion region of the tantalum wire 11 is unexpectedly bent, whereby the welding defect rate may be further decreased.

Generally, in the case in which the tantalum wire 11 has a relatively large diameter so as to have a curved surface approximating a circular shape, an end portion of the wire connection part 21 may line-contact the non-insertion region of the tantalum wire 11.

For example, when the tantalum wire 11 is resistance-welded to the end portion of the wire connection part 21, in the case in which an area in which the end portion of the wire connection part 21 contacts the tantalum wire 11 is excessively small, it may be difficult to uniformly adjust resistance heat of a welding apparatus.

In the exemplary embodiment of the present disclosure, the end portion of the wire connection part 21 may contact the first region 11a having the smallest thickness but having the widest width in the non-insertion region of the tantalum wire 11. In addition, since the area in which the wire connection part 21 contacts the tantalum wire 11 is increased, the first region 11a of the tantalum wire 11 and the end portion of the wire connection part 21 do not line-contact each other, but may surface-contact each other. Therefore, the resistance heat of the welding apparatus may be uniformly adjusted, thereby significantly decreasing a welding defect rate.

Hereinafter, a method of manufacturing a tantalum capacitor according to an exemplary embodiment of the present disclosure will be described.

First, a positive electrode lead frame material and negative electrode lead frame material formed using conductive materials and having a flat shape maybe prepared, respectively.

Then, a portion of the positive electrode lead frame material may be bent upwardly using a mold, or the like, to prepare the positive electrode lead frame 20 including the positive electrode terminal part (22 and 23) and the wire connection part 21.

In this case, the wire connection part 21 may be bent so as to have a bending angle (θ) of 87 to 93° with respect to the first portion 22 of the positive electrode terminal part. The positive electrode terminal part may be maintained to have a constant contact area between the wire connection part 21 and the non-insertion region of the tantalum wire 11 in this range of the bending angle to significantly decrease a welding defect rate.

Meanwhile, a portion of the negative electrode lead frame material may become a mounting part to be described below, and the remaining part thereof may configure the negative electrode lead frame serving as the negative electrode terminal part.

Next, the positive electrode terminal part of the positive electrode lead frame 20 and the negative electrode lead frame 30 may be disposed to be spaced apart from each other in the length direction so as to oppose each other.

When the positive electrode terminal part of the positive electrode lead frame and the negative electrode lead frame are disposed horizontally and are disposed on the same plane in the length direction, stability of solders may be secured at the time of mounting the tantalum capacitor on a board.

In the case in which the positive electrode terminal part and the negative electrode lead frame are misaligned from each other in the width direction, a contact area between the positive electrode terminal part and the solder and a contact area between the negative electrode lead frame and the solder at the time of mounting the tantalum capacitor on the board may be different from each other, such that an equivalent series resistance (ESR) of the tantalum capacitor may be deteriorated.

Next, the capacitor body 10 may be mounted on an upper surface of a front part of the mounting part 31 of the negative electrode lead frame 20. The part in which the capacitor body 10 is mounted may be provided as the mounting part 31.

Here, before the capacitor body 10 is mounted on the upper surface of the mounting part 31 of the negative electrode lead frame 30, a conductive adhesive is applied to the upper surface of the mounting part 31 of the negative electrode lead frame 30 to form the conductive adhesive layer 50 having a predetermined thickness, whereby adhesion strength between the negative electrode lead frame 30 and the capacitor body 10 may be improved.

Then, in order to harden the conductive adhesive layer 50, a hardening process may be performed at a temperature of about 160 to 170° C. under a vacuum condition for about one hour, as necessary.

In addition, the non-insertion region of the tantalum wire 11 and the wire connection part 21 may be resistance-welded to each other so as to be electrically connected to each other in a state in which the non-insertion region of the tantalum wire 11 exposed through one end surface of the capacitor body 10 in the length direction contacts the end portion of the wire connection part 21 of the positive electrode lead frame 20.

Here, the tantalum wire 11 may be formed so that the non-insertion region thereof includes a plurality of regions having different thicknesses and widths.

In addition, the tantalum wire 11 may be formed so that a thickness of the non-insertion region thereof is gradually decreased and a width of the non-insertion region thereof is gradually increased in a direction in which the tantalum wire 11 is exposed.

Therefore, when the end portion of the wire connection part 21 surface-contacts the non-insertion region of the tantalum wire 11 and is then resistance-welded to the non-insertion region of the tantalum wire 11, a contact area between the non-insertion region of the tantalum wire 11 and the wire connection part 21 is increased, whereby a welding defect rate may be decreased.

Next, an epoxy molding compound (EMC) process may be performed so as to enclose the tantalum wire 11 and the capacitor body 10, thereby forming the molding part 40.

In this case, the molding may be performed so that the negative electrode terminal part 32 of the negative electrode lead frame 30 and the positive electrode lead frame 20 may be partially exposed through both end surfaces of the molding part 40 in the length direction, respectively.

The molding part 40 may serve to protect the tantalum wire 11 and the capacitor body 10 from the outside.

Then, in order to harden the molding part 40, a hardening process may be performed at a temperature of about 160 to 170° C. under a vacuum condition for about one hour, as necessary. This hardening process may be changed depending on a material of an epoxy mold.

Next, the negative electrode terminal part 32 of the negative electrode lead frame 30 exposed to the other end surface of the molding part 40 in the length direction may be vertically bent upwardly and be attached to an end surface of a rear portion of the molding part 40.

In addition, the positive electrode terminal part 23 of the positive electrode lead frame 20 exposed to one end surface of the molding part 40 in the length direction may be vertically bent upwardly and be attached to an end surface of a front portion of the molding part 40, thereby completing the tantalum capacitor 1.

Here, before the positive electrode terminal part 23 or the negative electrode terminal part 32 is bent, an adhesive may be applied to one surface of the positive electrode terminal part 23 or the negative electrode terminal part 32 to increase adhesion strength between the positive electrode terminal part 23 or the negative electrode terminal part 32 and the molding part 40, as necessary.

Meanwhile, the positive electrode terminal part 23 and the negative electrode terminal part 32 may be cut to have an appropriate length in consideration of a size of the capacitor body 10, or the like, before being bent.

In addition, as shown in FIG. 4, the tantalum wire 11 maybe cut before the capacitor body 10 is mounted on the mounting part 31 of the negative electrode lead frame 30. In this case, wire burrs may occur on a distal end of the non-insertion region of the tantalum wire 11 due to abrasion of a blade.

The wire burrs may decrease a contact area between the wire connection part 21 of the positive electrode lead frame 20 and the tantalum wire 11 and allow the wire connection part 21 of the positive electrode lead frame 20 and the tantalum wire 11 not to appropriately surface-contact each other at the time of contacting each other, thereby causing a defect such as short circuits at the time of performing resistance-welding.

In order to prevent the defect as short circuits, a length I of the wire burr may be 0.03 mm or less. However, the present disclosure is not limited thereto.

According to exemplary embodiments of the present disclosure, the bending angle between the positive electrode terminal part of the positive electrode lead frame and the wire connection part connected to the non-insertion region of the tantalum wire is set to 87 to 93°, such that a contact area between the non-insertion region of the tantalum wire and the end portion of the wire connection part at the time of welding and adhering the non-insertion region of the tantalum wire and the end portion of the wire connection part to each other may be constantly maintained, whereby a welding defect rate may be decreased.

While exemplary embodiments have been shown and described above, it will be apparent to those skilled in the art that modifications and variations could be made without departing from the spirit and scope of the present disclosure as defined by the appended claims.

What is claimed is:

1. A tantalum capacitor comprising:
a capacitor body containing tantalum powder particles;
a tantalum wire having an insertion region positioned in the capacitor body and a non-insertion region exposed through one end surface of the capacitor body in a length direction of the capacitor body;
a molding part enclosing the capacitor body and the tantalum wire;
a positive electrode lead frame including a positive electrode terminal part exposed through one end surface of the molding part in the length direction of the molding part and a wire connection part bent from the positive electrode terminal part so as to be connected to the non-insertion region of the tantalum wire, the wire connection part having a bending angle of 87 to 93° with respect to the positive electrode terminal part; and
a negative electrode lead frame in which the capacitor body is mounted, to be exposed to the other end surface of the molding part in the length direction.

2. The tantalum capacitor of claim 1, wherein the non-insertion region of the tantalum wire comprises a plurality of regions having different thicknesses and widths.

3. The tantalum capacitor of claim 1, wherein a thickness of the non-insertion region of the tantalum wire is gradually decreased and a width of the non-insertion region of the tantalum wire is gradually increased in a direction in which the tantalum wire is exposed.

4. The tantalum capacitor of claim 1, wherein the wire connection part surface-contacts the non-insertion region of the tantalum wire.

5. The tantalum capacitor of claim 1, wherein the positive electrode terminal part of the positive electrode lead frame is bent to be closely adhered to one end surface of the molding part in the length direction.

6. The tantalum capacitor of claim 1, wherein a portion of the negative electrode lead frame exposed through the other end surface of the molding part in the length direction is bent to be closely adhered to the other end surface of the molding part in the length direction.

7. The tantalum capacitor of claim 1, further comprising a conductive adhesive layer disposed between a mounting surface of the capacitor body and the negative electrode lead frame.

8. A method of manufacturing a tantalum capacitor, comprising:
preparing a positive electrode lead frame including a wire connection part having a bending angle of 87 to 93° with respect to a positive electrode terminal part having a flat shape by bending the positive electrode terminal part upwardly and preparing a negative electrode lead frame having a flat shape;
disposing the positive electrode terminal part of the positive electrode lead frame and the negative electrode lead frame so as to be spaced apart from each other;
mounting a capacitor body on an upper surface of the negative electrode lead frame and connecting an end portion of the wire connection part of the positive electrode lead frame to a non-insertion region of a tantalum wire exposed through one end surface of the capacitor body in the length direction of the capacitor body;
molding a resin so as to enclose the capacitor body and the tantalum wire and forming a molding part so that the positive electrode terminal part of the positive electrode lead frame and the negative electrode lead frame are partially exposed to both ends of the molding part in the length direction of the molding part, respectively; and
bending the positive electrode terminal part of the positive electrode lead frame upwardly to closely adhere the positive electrode terminal part to one end surface of the molding part in the length direction and bending the exposed portion of the negative electrode lead frame upwardly to closely adhere the exposed portion to the other end surface of the molding part in the length direction.

9. The method of manufacturing a tantalum capacitor of claim 8, wherein the tantalum wire is formed so that the non-insertion region of the tantalum wire comprises a plurality of regions having different thicknesses and widths.

10. The method of manufacturing a tantalum capacitor of claim 8, wherein the tantalum wire is formed so that a thickness of the non-insertion region is gradually decreased and a width of the non-insertion region is gradually increased in a direction in which the tantalum wire is exposed.

11. The method of manufacturing a tantalum capacitor of claim 8, wherein the wire connection part surface-contacts the non-insertion region of the tantalum wire and is then connected to the non-insertion region of the tantalum wire by resistance welding.

12. The method of manufacturing a tantalum capacitor of claim 8, further comprising, before the mounting of the capacitor body on the upper surface of the negative electrode lead frame, disposing a conductive adhesive layer by applying a conductive adhesive to the upper surface of the negative electrode lead frame.

13. The method of manufacturing a tantalum capacitor of claim 8, wherein the capacitor body is mounted on the upper surface of the negative electrode lead frame after the non-insertion region of the tantalum wire is cut to have a predetermined length, and wire burrs occurring on a distal end of the non-insertion region of the tantalum wire have a length of 0.03 mm or less.
